(19) United States
(12) Patent Application Publication
(10) Pub. No.: US 2025/0328759 A1
(43) Pub. Date: Oct. 23, 2025

(54) METHOD, ELECTRONIC DEVICE, STORAGE MEDIUM, AND PROGRAM PRODUCT FOR TRAINING MULTI-TASK MODEL

(71) Applicant: Beijing Youzhuju Network Technology Co., Ltd., Beijing (CN)

(72) Inventors: Dongjun QIAN, Beijing (CN); Kai SU, Beijing (CN); Wen ZHOU, Beijing (CN)

(21) Appl. No.: 19/187,329

(22) Filed: Apr. 23, 2025

(30) Foreign Application Priority Data
Apr. 23, 2024 (CN) 202410495263.8

(51) Int. Cl. G06N 3/08

(52) U.S. Cl. CPC G06N 3/08

(57) ABSTRACT

Embodiments of the present disclosure provide a method, an electronic device, a computer-readable storage medium, and a computer program product for training a multi-task model. The multi-task model includes a shared sub-model and a plurality of dedicated sub-models corresponding to a plurality of tasks respectively, and the method includes: performing operations for each of the plurality of tasks respectively: determining a trigger state of the task based on association information of the task; in response to the trigger state indicating that the task is triggered for training the multi-task model, obtaining a set of training data corresponding to the task; and training the shared sub-model and a dedicated sub-model corresponding to the task with the set of training data corresponding to the task.

### CROSS-REFERENCE TO RELATED APPLICATION(S)

This application claims priority to Chinese Application No. 202410495263.8 filed on Apr. 23, 2024, the disclosure of which is incorporated herein by reference in its entirety.

### FIELD

The present disclosure generally relates to the field of computers, and more particularly, to a method, an electronic device, and a computer-readable storage medium for training a multi-task model.

### BACKGROUND

The applications of neural network models have become increasingly popular and are playing an increasingly important role in various task requirements.

### SUMMARY

According to example embodiments of the present disclosure, a method for training a multi-task model, an electronic device, and a computer storage medium are provided.

In a first aspect of the present disclosure, a method for training a multi-task model is provided, the multi-task model includes a shared sub-model and a plurality of dedicated sub-model corresponding to a plurality of tasks respectively, and the method includes: performing operations for each of the plurality of tasks respectively; determining a trigger state of the task based on association information of the task; in response to the trigger state indicating that the task is triggered for training the multi-task model, obtaining a set of training data corresponding to the task; and training the shared sub-model and a dedicated sub-model corresponding to the task with the set of training data corresponding to the task.

In a second aspect of the present disclosure, an electronic device is provided, including: at least one processing unit; at least one memory coupled to the at least one processing unit and storing instructions executable by the at least one processing unit, the instructions, when executed by the at least one processing unit, causing the electronic device to perform a method for training a multi-task model, the multi-task model including a shared sub-model and a plurality of dedicated sub-models corresponding to a plurality of tasks respectively, the method including: performing operations for each of the plurality of tasks respectively; determining a trigger state of the task based on association information of the task; in response to the trigger state indicating that the task is triggered for training the multi-task model, obtaining a set of training data corresponding to the task; and training the shared sub-model and a dedicated sub-model corresponding to the task with the set of training data corresponding to the task.

In a third aspect of the present disclosure, a computer-readable storage medium is provided, the computer-readable storage medium has machine-executable instructions stored thereon, and the machine-executable instructions, when executed by a device, cause the device to perform a method for training a multi-task model, the multi-task model includes a shared sub-model and a plurality of dedicated sub-models corresponding to a plurality of tasks respectively, and the method includes: performing operations for each of the plurality of tasks respectively; determining a trigger state of the task based on association information of the task; in response to the trigger state indicating that the task is triggered for training the multi-task model, obtaining a set of training data corresponding to the task; and training the shared sub-model and the dedicated sub-model corresponding to the task with the set of training data corresponding to the task.

In a fourth aspect of the present disclosure, a computer program product is provided, including computer-executable instructions, where the computer-executable instructions, when executed by a processor, implement a method for training a multi-task model, the multi-task model including a shared sub-model and a plurality of dedicated sub-models corresponding to a plurality of tasks respectively, and the method including: performing operations for each of the plurality of tasks respectively; determining a trigger state of the task based on association information of the task; in response to the trigger state indicating that the task is triggered for training the multi-task model, obtaining a set of training data corresponding to the task; and training the shared sub-model and a dedicated sub-model corresponding to the task with the set of training data corresponding to the task.

The Summary is to introduce a selection of concepts in a simplified form that are further described below in the Detailed Description. The Summary is not intended to identify key features or essential features of the present disclosure, nor is it intended to limit the scope of the present disclosure. Other features of the present disclosure will become readily apparent from the following description.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numerals denote the same or similar elements, and:

FIG. 1 illustrates a schematic diagram of an example system in which embodiments of the present disclosure can be implemented;

FIG. 2 illustrates a flowchart of a method for training a multi-task model according to an embodiment of the present disclosure;

FIG. 3 illustrates a schematic block diagram of training a multi-task model according to an embodiment of the present disclosure;

FIG. 4 illustrates a flowchart of a method for obtaining a set of training data according to an embodiment of the present disclosure;

FIG. 5 illustrates a schematic diagram of a parameter synchronization process according to an embodiment of the present disclosure;

FIG. 6 illustrates a schematic block diagram of an example apparatus according to some embodiments of the present disclosure; and

FIG. 7 illustrates a block diagram of an example device that can be used to implement the embodiments of the present disclosure.

### DETAILED DESCRIPTION OF EMBODIMENTS

Embodiments of the present disclosure will be described in more detail below with reference to the drawings. While certain embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are for illustrative purposes only and are not intended to limit the scope of the present disclosure.

Although at present, corresponding neural network models can be quickly trained for various tasks, and the trained neural network models can meet corresponding task requirements, users have realized that the separate training of corresponding neural network models for each task requirement is costly. Therefore, there is an urgent need for a multi-task model that can meet various task requirements.

Since there is a problem of high cost in separately training corresponding neural network models for each task requirement, it is expected that a multi-task model that can meet various task requirements can be trained and obtained. However, existing training frameworks and training methods for neural network models require unified model input and unified model output, thus, there is a great challenge in training the multi-task model using different datasets for different tasks.

In view of this, an embodiment of the present disclosure provides a method for training a multi-task model. The multi-task model includes a shared sub-model and a plurality of dedicated sub-models corresponding to a plurality of tasks respectively, and the method includes: performing operations for each of the plurality of tasks respectively; determining a trigger state of the task based on association information of the task; in response to the trigger state indicating that the task is triggered for training the multi-task model, obtaining a set of training data corresponding to the task; and training the shared sub-model and a dedicated sub-model corresponding to the task with the set of training data corresponding to the task.

According to the method of the embodiment of the present disclosure, the multi-task model can be trained with multiple sets of data that support various tasks, so that the trained model can support various application scenarios based on different tasks, and the cost of the model is significantly reduced. In addition, according to the multi-task model of the embodiment of the present disclosure, different data can be mapped to a feature embedding model of the same space, so that supplementary feature data can be provided for different application scenarios, and the different application scenarios can be functionally expanded.

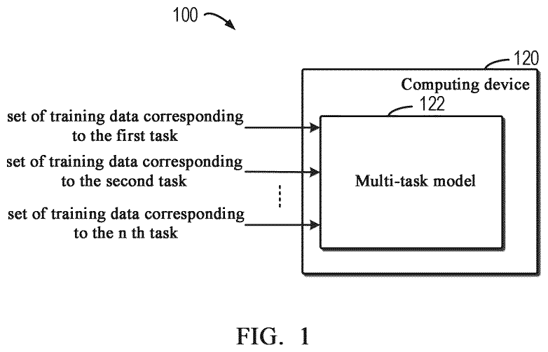

The embodiments of the present disclosure will be further described in detail below with reference to the drawings, and FIG. 1 illustrates a schematic diagram of an example environment 100 in which the embodiments of the present disclosure can be implemented. The example environment 100 includes a computing device 120, and the computing device 120 may include a multi-task model 122. The multi-task model 122 may support a plurality of tasks, such as, but not limited to, an image classification task, an image localization task, or an image detection task, after being trained. In addition, the multi-task model 122 may also be provided separately from the computing device 120. For example, the multi-task model 122 may be provided on another computing device, and the multi-task model 122 may be trained by the computing device 120. The present disclosure does not limit the positional relationship between the multi-task model 122 and the computing device 120.

The computing device 120 includes but is not limited to a personal computer, a server computer, a handheld or laptop device, a mobile device (such as a mobile phone, a personal digital assistant (PDA), a media player, etc.), a multi-processor system, a consumer electronic product, a wearable electronic device, a smart home device, a small computer, a large computer, an edge computing device, a distributed computing environment including any of the above systems or devices, and the like.

In some embodiments, the computing device 120 may be used to train the multi-task model 122. The multi-task model 122 may include a shared sub-model and a plurality of dedicated sub-models corresponding to a plurality of tasks respectively. The shared sub-model may be shared by the plurality of tasks. In other words, the computing device 120 may adjust the parameters of the shared sub-model in the process of training the multi-task model 122 for each task. In addition, the computing device 120 may also adjust the parameters of the dedicated sub-model corresponding to the task in the process of training the multi-task model 122 for each task, without adjusting the parameters of the dedicated sub-models corresponding to other tasks.

In the process of training the multi-task model 122, the computing device 120 may train the multi-task model 122 in a plurality of training steps. In each training step, the computing device 120 may obtain a set of training data corresponding to a first task, and train the multi-task model 122 by adjusting the model parameters of the shared sub-model and the parameters of a first dedicated sub-model corresponding to the first task. Then, the computing device 120 may obtain a set of training data corresponding to a second task, and train the multi-task model 122 in this step by adjusting the model parameters of the shared sub-model and the parameters of a second dedicated sub-model corresponding to the second task. The computing device 120 may then obtain set of training data corresponding to the remaining tasks that are triggered for training the multi-task model in this training step respectively, to train the shared sub-model and corresponding dedicated sub-models. The computing device 120 may perform a plurality of training steps, so as to implement the training of the multi-task model 122.

In some embodiments, the computing device 120 may perform the following operations for each of the plurality of tasks respectively: determining a trigger state of the task based on association information of the task; in response to the trigger state indicating that the task is triggered for training the multi-task model 122, obtaining a set of training data corresponding to the task; and training the shared sub-model and a dedicated sub-model corresponding to the task in the multi-task model with the set of training data corresponding to the task.

According to the method for multi-task training of the embodiment of the present disclosure, the computing device 120 may train the multi-task model 122 with multiple sets of data that support various tasks, so that the trained model can support various application scenarios based on different tasks, and the cost of the model is significantly reduced. In addition, according to the multi-task model 122 of the embodiment of the present disclosure, different data can be mapped to a feature embedding model of the same space, so that supplementary feature data can be provided for different application scenarios, and the different application scenarios can be functionally expanded.

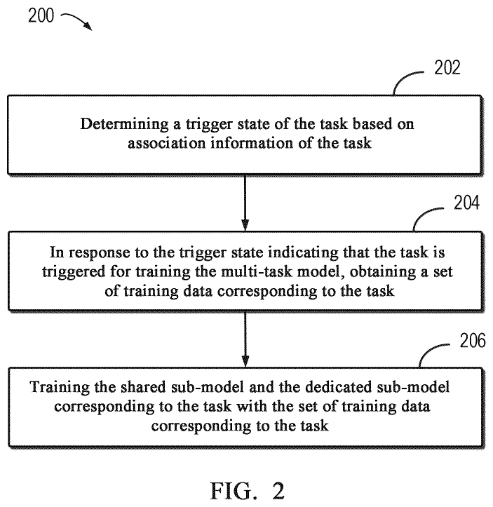

The block diagram of the example environment 100 in which the embodiments of the present disclosure can be implemented is described above in conjunction with FIG. 1. The flowchart of a method 200 for training an encoder according to an embodiment of the present disclosure is described below in conjunction with FIG. 2. FIG. 2 illustrates a flowchart of a method for training a multi-task model according to an embodiment of the present disclosure. The method 200 may be performed at the computing device 120 in FIG. 1 and any suitable computing device. It should be understood that the numbers in the flowchart of the method 200 do not indicate the order in which these steps are performed, some or all of these steps may be performed in parallel, or the order of performing these steps may be interchanged, which is not limited in the present disclosure. In addition, the method 200 in FIG. 2 may include additional steps not shown and/or the shown steps may be omitted, and the scope of the present disclosure is not limited in this respect.

The method 200 shown in FIG. 2 is the operation performed for each of the plurality of tasks supported by the multi-task model 122 in each training step for training the multi-task model. In each training step, the computing device 120 may perform the operations in the method 200 shown in FIG. 2 for each of the plurality of tasks respectively, and after the computing device 120 performs the operations in the method 200 for each task, the computing device 120 may proceed to the next training step, and then perform the operations in the method 200 shown in FIG. 2 for each of the plurality of tasks respectively.

The computing device 120 may perform the operations in the method 200 in FIG. 2 for each of the plurality of tasks respectively in a plurality of training steps, until a predetermined number of training steps are met. The operations in the method 200 performed by the computing device 120 for each of the plurality of tasks in one training step will be described below with reference to FIG. 2.

As shown in FIG. 2, in block 202, the computing device 120 may determine the trigger state of a task based on the association information of the task. In some embodiments, the multi-task model 122 may be used to support a plurality of tasks, for example, including task Task 1, task Task 2, . . . , task Task m (m is a positive integer, representing the number of the plurality of tasks supported by the multi-task model 122). In the following, for the convenience of description, the task Task i (1≤i≤m) in the plurality of tasks will be taken as an example for description.

The computing device 122 may determine the trigger state of the task Task i based on the association information of the task Task i. In some embodiments, Task i may be associated with a multiple sets of sample data. In other words, the multiple sets of sample data may be used to train the multi-task model 122 for the task Task i, so that the multi-task model 122 may support the task Task i. For example, a first set of sample data A1, a second set of sample data A2, and a jth set of sample data Aj are associated with the task Task i, and each set of sample data of the first set of sample data A1, the second set of sample data A2, and the jth set of sample data Aj may be labeled for the task Task i.

In some embodiments, the association information of Task i may include: a data loader Dataloader corresponding to the task Task i, and the data loader Dataloader is associated with a multiple sets of sample data for the task Task i. Still taking the example described above as an example, in the example where the first set of sample data A1, the second set of sample data A2, and the jth set of sample data Aj are associated with the task Task i, the data loader Dataloader in the association information of Task i may be associated with the first set of sample data A1, the second set of sample data A2, and the jth set of sample data Aj. For example, the data loader Dataloader may be associated with an index Index A1 of the first set of sample data A1, an index Index A2 of the second set of sample data A2, and an index Index Aj of the jth set of sample data Aj. Via the data loader, the computing device 120 may obtain sample data in the set of sample data associated with the task Task i.

In some embodiments, the association information of Task i may further include association model information Model corresponding to the task Task i, and the association model information Model includes dedicated sub-model information corresponding to the task in the multi-task model. In addition, the association information of Task i may further include loss information Func corresponding to the task, that is, a method of calculating a loss adopted in the process of training the multi-task model 122 for the task Task i. In some embodiments, the association information of Task i may further include scheduling information Scheduler corresponding to the task Task i. In some embodiments, the scheduling information may include a trigger value set for the task Task i in each training step. The trigger value may indicate a probability that the task is triggered in the training step. In some embodiments, the trigger value may be represented as a value in a range of [0, 1], and is proportional to a frequency at which the task is executed.

In some embodiments, the association information of each task may be represented by a quadruple. For example, the association information of the task may be represented as (Dataloader; Model; Func; Scheduler). In addition, it can be understood that the association information may also be represented in other suitable ways, which is not limited in the present disclosure.

The computing device 120 may determine the trigger state of the task based on the association information of the task. In some embodiments, the trigger state may indicate whether the task is triggered for training the multi-task model, that is, whether to train the multi-task model with the set of sample data corresponding to the task, so that the multi-task model may be used to support the task.

Specifically, taking the task Task i as an example, the computing device 120 may determine the trigger state of the task Task i based on the scheduling information Scheduler in the association information of the task Task i. The scheduling information Scheduler may include a trigger value of the task Task i in at least one training step. In some embodiments, the scheduling information Scheduler may include a trigger value set for the task Task i in each training step. For example, the scheduling information Scheduler may be represented as {step 1, trigger value 1; step 2, trigger value 2; . . . step s, trigger value s}. The trigger value may be represented as a value in a range of [0, 1], and is proportional to a frequency at which the task is executed. For example, if the task is executed at a relatively high frequency, the trigger value is set to be relatively high, such as 0.8, 0.9, or 1. On the contrary, if the task is executed at a relatively low frequency, the trigger value is set to be relatively low, such as 0.2, 0.1, or 0.

In some embodiments, the computing device 120 may calculate a difference value D between an integer A corresponding to a product of a current training step number S and a trigger value of the current step, and an integer B corresponding to a product of a number (S-1) of the previous training step and the trigger value of the current step. The computing device 120 may compare the difference value D with a predetermined value (for example, 1), and determine the trigger state of the task according to a comparison result. For example, when the difference value D is not less than a predetermined number 1, the computing device 120 determines that the task is triggered for training the multi-task model. When the difference value D is less than the predetermined number 1, the computing device 120 determines that the task is not triggered for training the multi-task model.

In block 204, the computing device 120 may obtain a set of training data corresponding to the task in response to the trigger state indicating that the task is triggered for training the multi-task model. In some embodiments, the computing device 120 determines that the trigger state indicates that the task is triggered for training the multi-task model, that is, the multi-task model is trained with at least a part of sample data in the multiple sets of sample data corresponding to the task, so that the trained multi-task model may support the task.

In some embodiments, the set of training data may include a set of training data of a batch from the multiple sets of sample data associated with the task. The implementation process for obtaining the set of training data will be described below with reference to the drawings.

In block 206, the computing device 120 may train the shared sub-model and the dedicated sub-model corresponding to the task with the set of training data corresponding to the task. In some embodiments, in response to the trigger state of the task indicating that the task is triggered for training the multi-task model, the computing device 120 may determine the dedicated sub-model information corresponding to the task based on the association model information in the association information. In addition, the computing device 120 may train the shared sub-model and the dedicated sub-model corresponding to the task based on the training sample data obtained in block 204. The computing device 120 may determine a loss for the task based on the loss information corresponding to the task indicated in the association information, and adjust the parameters of the shared sub-model and the parameters of the dedicated sub-model corresponding to the task based on the loss, so as to implement the training of the multi-task model for the task.

In addition, in some embodiments, the computing device 120 may further perform the operations in the method 200 for a next task of the plurality of tasks in response to the trigger state indicating that the task is not triggered for training the multi-task model. For the specific implementation process of the computing device 120 performing the operations in the method 200 for the next task, reference may be made to the above description for understanding, and for the sake of brevity, details are not described herein again.

In some embodiments, after the computing device 120 completes the operations 202, 204, and 206 for the task, the computing device 120 continues to perform the operations 202, 204, and 206 for the next task, and so on, until the above operations 202, 204, and 206 are completed for all tasks. The computing device 120 may increase a count that represents the number of training steps by 1 to proceed to a next training step, and in the next training step, perform the operations 202, 204, and 206 in the method 200 for each of all tasks respectively, until a predetermined number of training steps are met. Thus, a trained multi-task model that supports a plurality of tasks may be obtained.

Advantageously, according to the method of the embodiment of the present disclosure, the multi-task model can be trained with multiple sets of data that support various tasks, so that the trained model can support various application scenarios based on different tasks, and the cost of the model is significantly reduced. In addition, according to the multi-task model of the embodiment of the present disclosure, different data can be mapped to a feature embedding model of the same space, so that supplementary feature data can be provided for different application scenarios, and the different application scenarios can be functionally expanded.

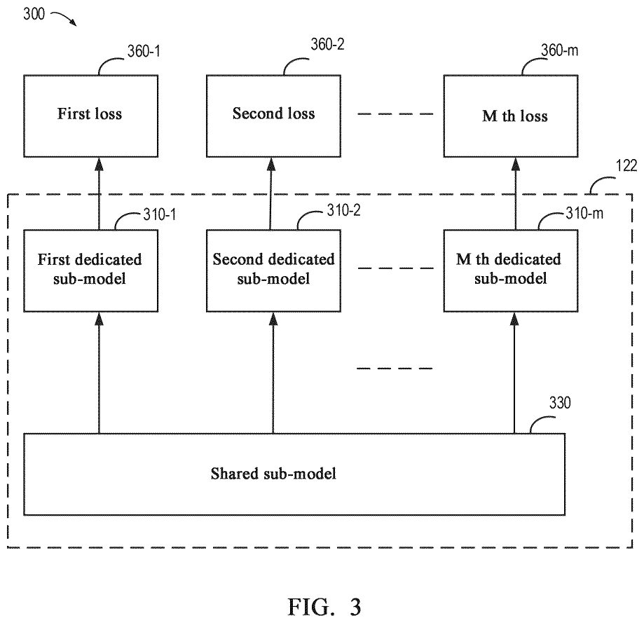

The exemplary implementation process of training the multi-task model according to the embodiment of the present disclosure will be described below with reference to FIG. 3. FIG. 3 illustrates a schematic block diagram of training a multi-task model according to an embodiment of the present disclosure. The multi-task model 122 shown in FIG. 3 includes a shared sub-model 330 and dedicated sub-models 310-1, 310-2, . . . , 310-m associated with a plurality of tasks respectively, wherein m is the number of tasks supported by the multi-task model 122. For example, task Task 1 corresponds to the first dedicated sub-model 310-1, task Task 2 corresponds to the second dedicated sub-model 310-2, and so on, task Task m corresponds to the mth dedicated sub-model 310-m.

For each task Task k (1≤k≤m), a quadruple representing the association information of the task Task k, for example, (Dataloader; Model; Func; Scheduler), may be constructed, wherein Dataloder is associated with a multiple sets of sample data for the task k, the association model information Model is used to represent information of a kth dedicated sub-model, Func represents a kth loss, and the scheduling information Scheduler sets a trigger value for the task k in each training step.

The computing device 120 may determine the trigger state of a task based on the association information of the task. Taking the current training step being the fifth step and performing operations for the first task Task 1 as an example, it is assumed that the trigger value of Task 1 in the fifth step is 1. The computing device 120 may calculate a difference value D based on the trigger value in the scheduling information in the association information of Task 1. The computing device 120 may calculate a difference value D between an integer A (for example, A=5) corresponding to a product of a current training step number S (for example, S=5) and a trigger value of the current step (for example, the trigger value is 1), and an integer B (for example, B=4) corresponding to a product of a number (S-1) (for example, S-1=4) of the previous training step and the trigger value of the current step (for example, the trigger value is 1). The computing device 120 may determine that the difference value D=1 is not less than the predetermined value 1, and thus may determine that the trigger state of the first task Task 1 indicates that the first task Task 1 is triggered for training the multi-task model 122.

The computing device may obtain a set of training data corresponding to the task. In some embodiments, the set of training data may include a set of training data of a batch from the multiple sets of sample data associated with the first task Task 1. The computing device 120 may train the shared sub-model 330 and the first dedicated sub-model 310-1 corresponding to the first task with the set of training data, and the first loss used in the training process may be determined according to the association loss information Func in the association information, such as the first loss 360-1 shown in FIG. 3. The computing device 120 may adjust the parameters of the shared sub-model 330 and the parameters of the first dedicated sub-model 310-1 corresponding to the first task based on the first loss 360-1.

After completing the operations for the first task, the computing device 120 may perform operations for the second task similar to the operations performed for the first task above. The computing device 120 may determine the trigger state of the second task based on the scheduling information in the association information of the second task. Assuming that the computing device 120 determines that the second task is not triggered for training the multi-task model in this training step, the computing device 120 performs the above operations for the next task, i.e., the third task.

The computing device 120 performs the above operations for each of the plurality of tasks, until performing the above operations for the mth task. Assuming that the computing device 120 determines that the trigger state of the task Task m indicates that the task is triggered for training the multi-task model, the computing device 120 obtains a set of training data corresponding to the task Task m, and adjusts the model parameters of the shared sub-model 330 and the m th dedicated sub-model 310-m with the m th loss 360-m, based on the set of training data, to train the multi-task model 122.

The computing device 120 may increase a count that represents the number of training steps by 1 to proceed to the next training step, and continue to perform the above operations for each task in the next training step, until a predetermined number of training steps are met, so as to implement the training of the multi-task model.

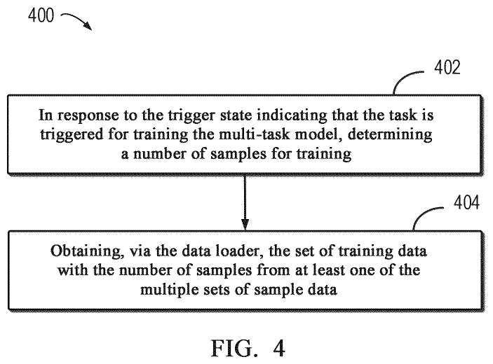

The flowchart of a method 400 for obtaining a set of training data corresponding to a task will be described below with reference to FIG. 4. FIG. 4 illustrates a flowchart of a method for obtaining a set of training data according to an embodiment of the present disclosure. The method 400 may be performed at the computing device 120 in FIG. 1 and any suitable computing device, and the method 400 may be an exemplary implementation of block 204 in FIG. 2. It should be understood that the numbers in the flowchart of the method 400 do not indicate the order in which these steps are performed, some or all of these steps may be performed in parallel, or the order of performing these steps may be interchanged, which is not limited in the present disclosure. In addition, the method 400 in FIG. 4 may include additional steps not shown and/or the shown steps may be omitted, and the scope of the present disclosure is not limited in this aspect.

In block 402, the computing device 120 may determine a number of samples for training in response to a trigger state of a task (for example, task Task i) indicating that the task is triggered for training the multi-task model. In some embodiments, after determining that the trigger state indicates that the task is used for training the multi-task model, the computing device 120 may further determine the number of samples num required for training the multi-task model for the task in the current training step. The number of samples may be preset, representing the number of training samples in a batch of training sample data.

In block 404, the computing device 120 may obtain, via the data loader in the association information of the task, the set of training data with the number of samples num determined in block 402 from at least one of the multiple sets of sample data corresponding to the task.

In some embodiments, each of the plurality of tasks for training the multi-task model may have a corresponding multiple sets of sample data. For example, illustratively, the task Task i may have associated sets of sample data: a first set of sample data A1, a second set of sample data A2, and a j th set of sample data Aj; and the task Task (i+q) may have associated sets of sample data: a third set of sample data A3, a sixth set of sample data A6, and a jth set of sample data Aj.

The computing device 120 may obtain, via the data loader of the task, the set of training data with the number of samples num determined in block 402 from at least one of the multiple sets of sample data corresponding to the task. For example, for the task Task i, the data loader Dataloader corresponding to the task may obtain num sample data from at least one of the first set of sample data A1, the second set of sample data A2, and the jth set of sample data Aj, for example, obtain num sample data from the first set of sample data A1. Accordingly, the computing device 120 may obtain the num sample data from the first set of sample data A1, and use the num sample data as the set of training data for training the multi-task model in this step. For example, the computing device 120 may adjust the parameters of the shared sub-model and the dedicated sub-model corresponding to the task based on the num sample data, so as to train the multi-task model.

In some embodiments, a first multiple sets of sample data associated with a first task of the plurality of tasks and a second multiple sets of sample data associated with a second task of the plurality of tasks at least partially overlap. For example, as in the example described above, the task Task i may have associated sets of sample data: a first set of sample data A1, a second set of sample data A2, and a jth set of sample data Aj; and the task Task (i+q) may have associated sets of sample data: a third set of sample data A3, a sixth set of sample data A6, and a jth set of sample data Aj. The task Task i and the task Task (i+q) have an overlapping set of sample data Aj.

In addition, in some embodiments, a first multiple sets of sample data associated with a first task of the plurality of tasks and a second multiple sets of sample data associated with a second task of the plurality of tasks do not overlap. In some embodiments, a first multiple sets of sample data associated with a first task of the plurality of tasks and a second multiple sets of sample data associated with a second task of the plurality of tasks may completely overlap.

In some embodiments, since different tasks may adjust the model parameters of the shared sub-model when triggered, but may not adjust the parameters of dedicated sub-models corresponding to tasks other than the task itself. For example, after training the multi-task model for the first task, the parameters of the shared sub-model are adjusted, and the parameters of the first dedicated sub-model are also adjusted. The computing device 120 continues to train the model for the second task (assuming that the trigger state of the second task indicates that the second task is used for training the multi-task model), but since the parameters of the second dedicated sub-model corresponding to the second task remain in the adjusted state in the previous training step, and the parameters of the shared sub-model have been adjusted multiple times during the period from the previous training step to the current training step, a mismatch between the model parameters of the second dedicated sub-model and the shared sub-model may occur. In this regard, the method according to the embodiment of the present disclosure further includes a parameter synchronization process.

Specifically, in the parameter synchronization process, before training the shared sub-model and a dedicated sub-model corresponding to the task, the model parameters of the shared sub-model may be maintained unchanged and the parameters of the dedicated sub-model associated with the task may be updated. In some embodiments, the number of times of updating the parameters of the dedicated sub-model corresponding to the task is preset.

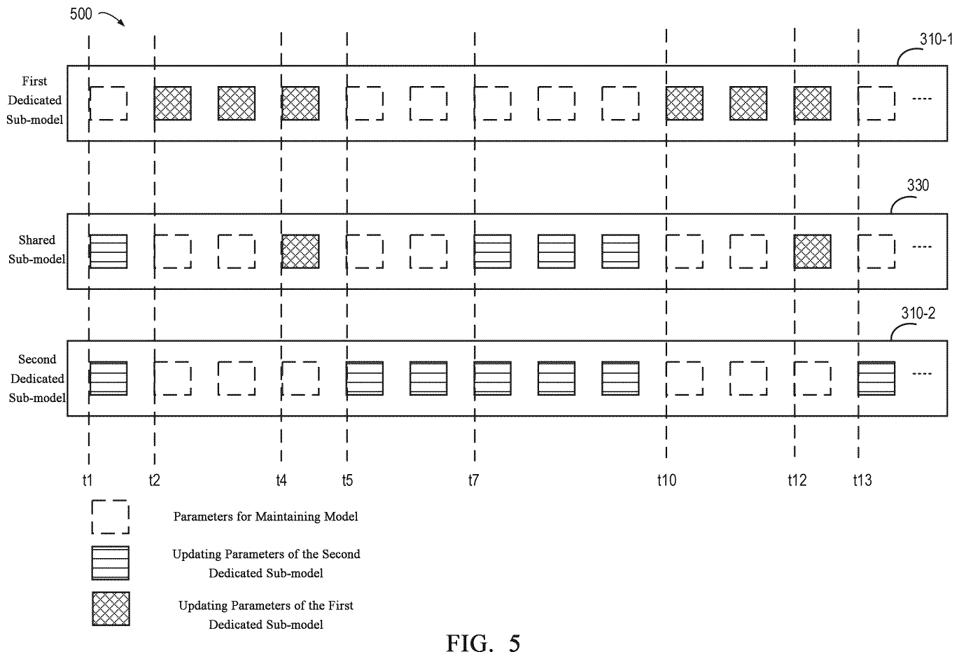

The parameter synchronization process will be described below with reference to FIG. 5. FIG. 5 illustrates a schematic diagram of a parameter synchronization process according to an embodiment of the present disclosure. Two dedicated sub-models are schematically shown in FIG. 5: a first dedicated sub-model 310-1 corresponding to the first task and a second dedicated sub-model 310-2 corresponding to the second task. A shared sub-model 330 is also shown in FIG. 5. The second task is triggered for training the multi-task model from time t1, and accordingly, the parameters of the second dedicated sub-model 310-1 corresponding to the second task and the parameters of the shared sub-model 330 are adjusted during the training process.

At time t2, the first task is triggered for training the multi-task model. The computing device 120 may perform the parameter synchronization process from time t2, that is, the computing device 120 may maintain the model parameters of the shared sub-model 330 unchanged and update the parameters of the first dedicated sub-model 310-1 before training the shared sub-model 330 and the first dedicated sub-model 310-1 corresponding to the first task. As shown in FIG. 5, during the time period from time t2 to time t4, the computing device only updates the parameters of the first dedicated sub-model 310-1, and keeps the parameters of the shared sub-model 330 unchanged. The computing device 120 trains the multi-task model for the first task from time t4 by adjusting the parameters of the shared sub-model 330 and the parameters of the first dedicated sub-model 310-1.

Similarly, the second task is triggered at time t5, and the computing device only updates the parameters of the second dedicated sub-model 310-2 and keeps the parameters of the shared sub-model 330 unchanged during the time period from time t5 to time t7. The computing device 120 starts to train the multi-task model at time t7, and trains the multi-task model for the second task by adjusting the parameters of the shared sub-model 330 and the parameters of the second dedicated sub-model 310-2 during the time period from time t7 to time t10.

Similarly, the first task is triggered at time t10, and the computing device only updates the parameters of the first dedicated sub-model 310-1 and keeps the parameters of the shared sub-model 330 unchanged during the time period from time t10 to time t12. The computing device 120 starts to train the multi-task model at time t12, and trains the multi-task model for the first task by adjusting the parameters of the shared sub-model 330 and the parameters of the first dedicated sub-model 310-1 during the time period from time t12 to time t13.

Advantageously, through the parameter synchronization process, the model parameters specific to each task may be better matched with the model parameters shared by different tasks, so that the parameters shared by different tasks and the parameters specific to each task may be stably updated, thereby causing the training of the multi-task model more effective.

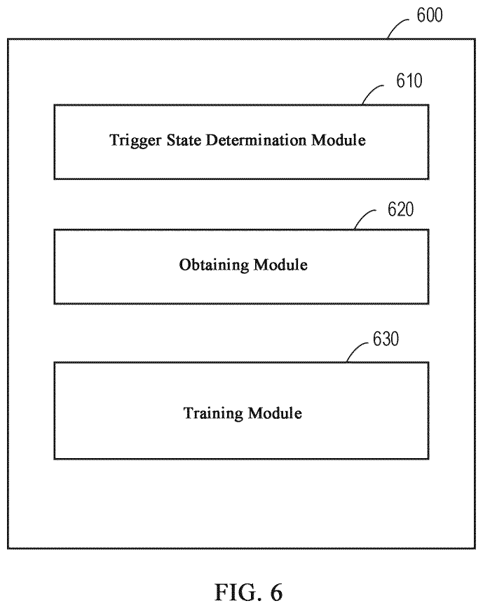

FIG. 6 illustrates a schematic block diagram of an example apparatus 600 according to some embodiments of the present disclosure. The apparatus 600 may be implemented by software, hardware, or a combination of both. As shown in FIG. 6, the apparatus 600 includes a trigger state determination module 610, an obtaining module 620, 6, and a training module 630.

In some embodiments, the apparatus 600 may perform operations for each of a plurality of tasks respectively, to implement the training of the multi-task model. For each task, the trigger state determination module 610 is configured to determine a trigger state of the task based on association information of the task. The obtaining module 620 is configured to, in response to the trigger state indicating that the task is triggered for training the multi-task model, obtain a set of training data corresponding to the task. The training module 630 is configured to train a shared sub-model in the multi-task model and a dedicated sub-model corresponding to the task with the set of training data corresponding to the task.

The apparatus 600 in FIG. 6 can be used to implement the processes described above in conjunction with FIG. 1 to FIG. 5, which will not be repeated here for the sake of brevity.

The division of modules or units in the embodiments of the present disclosure is schematic, and is only a logical function division, and there may be other division manners in actual implementation. In addition, the functional units in the disclosed embodiments may be integrated in one unit, or may exist physically alone, or two or more units may be integrated into one unit. The above integrated unit may be implemented in the form of hardware, or may be implemented in the form of software functional units.

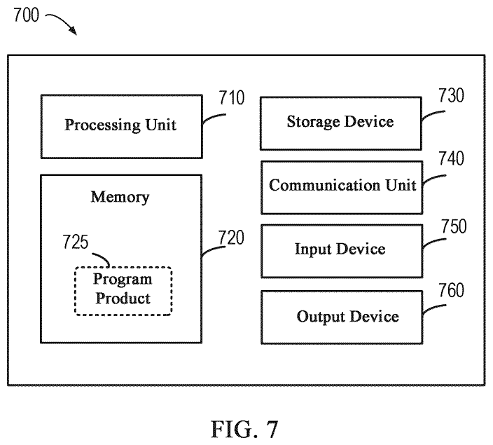

FIG. 7 illustrates a block diagram of an example device 700 that can be used to implement the embodiments of the present disclosure. It should be understood that the device 700 shown in FIG. 7 is only an example, and should not constitute any limitation to the function and scope of the implementations described herein. For example, the device 700 may correspond to the computing device 120 described herein in conjunction with FIG. 1, and may be used to perform the processes described above in FIG. 1 to FIG. 6.

As shown in FIG. 7, the device 700 is in the form of a general-purpose computing device. Components of the computing device 700 may include, but are not limited to, one or more processors or processing units 710, a memory 720, a storage device 730, one or more communication units 740, one or more input devices 750, and one or more output devices 760. The processing unit 710 may be a real or virtual processor and may perform various processes according to a program stored in the memory 720. In a multiprocessor system, a plurality of processing units executes computer-executable instructions in parallel to improve the parallel processing capability of the computing device 700.

The computing device 700 typically includes a plurality of computer storage media. Such media may be any available media accessible by the computing device 700, including but not limited to volatile and non-volatile media, and detachable and non-detachable media. The memory 720 may be a volatile memory (e.g., a register, a cache, a random access memory (RAM)), a non-volatile memory (e.g., a read only memory (ROM), an electrically erasable programmable read only memory (EEPROM), a flash memory), or any combination thereof. The storage device 730 may be a detachable or non-detachable medium, and may include a machine-readable medium, such as a flash drive, a disk, or any other medium, which may be capable of storing information and/or data (e.g., training data for training) and may be accessed within the computing device 700.

The computing device 700 may further include additional detachable/non-detachable, volatile/non-volatile storage media. Although not shown in FIG. 7, a disk drive for reading from or writing to a detachable, non-volatile disk (e.g., a “floppy disk”) and an optical disk drive for reading from or writing to a detachable, non-volatile optical disk may be provided. In these cases, each drive may be connected to a bus (not shown) by one or more data media interfaces. The memory 720 may include a computer program product 725 having one or more program modules configured to perform various methods or acts of various implementations of the present disclosure.

The communication unit 740 implements communication with other computing devices through communication media. Additionally, the functions of the components of the computing device 700 may be implemented by a single computing cluster or multiple computing machines that can communicate through communication connections. Therefore, the computing device 700 may operate in a networked environment using a logical connection to one or more other servers, network personal computers (PCs), or another network node.

The input device 750 may be one or more input devices, such as a mouse, a keyboard, a trackball, etc. The output device 760 may be one or more output devices, such as a display, a speaker, a printer, etc. The computing device 700 may further communicate with one or more external devices (not shown) through the communication unit 740 as required, the external devices such as storage devices, display devices, etc., communicate with one or more devices that enable a user to interact with the computing device 700, or communicate with any devices (e.g., a network card, a modem, etc.) that enable the computing device 700 to communicate with one or more other computing devices. Such communication may be performed via an input/output (I/O) interface (not shown).

According to example implementations of the present disclosure, a computer-readable storage medium is provided, having computer-executable instructions stored thereon, where the computer-executable instructions are executed by a processor to implement the method described above. According to example implementations of the present disclosure, a computer program product is further provided, which is physically stored on a non-transitory computer-readable medium and includes computer-executable instructions, and the computer-executable instructions are executed by a processor to implement the method described above. According to example implementations of the present disclosure, a computer program product is provided, having a computer program stored thereon, and the program, when executed by a processor, implements the method described above.

Various aspects of the present disclosure are described herein with reference to the flowcharts and/or block diagrams of the methods, apparatuses, devices, and computer program products implemented according to the present disclosure. It should be understood that each block of the flowcharts and/or block diagrams and a combination of blocks in the flowcharts and/or block diagrams may be achieved by a computer-readable program instruction.

These computer-readable program instructions may be provided to a processing unit of a general-purpose computer, a special-purpose computer, or other programmable data processing apparatus, to produce a machine, such that the instructions, when executed by the processing unit of the computer or other programmable data processing apparatus, produce an apparatus for implementing the functions/acts specified in one or more blocks in the flowcharts and/or block diagrams. These computer-readable program instructions may also be stored in a computer-readable storage medium. These instructions cause the computer, the programmable data processing apparatus, and/or other devices to work in a specific way. Thus, the computer-readable medium storing the instructions includes an article of manufacture, which includes instructions for implementing various aspects of the functions/acts specified in one or more blocks in the flowcharts and/or block diagrams.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions executed on the computer, other programmable data processing apparatus, or other device implement the functions/acts specified in one or more blocks in the flowcharts and/or block diagrams.

The flowcharts and block diagrams in the drawings illustrate the architecture, functionality, and operation of possible implementations of systems, methods and computer program products according to various implementations of the present disclosure. In this regard, each block in the flowcharts or block diagrams may represent a module, segment, or portion of instructions, which includes one or more executable instructions for implementing specified logical function(s). In some alternative implementations, the functions noted in the block may occur out of the order noted in the drawings. For example, two blocks shown in succession may, in fact, can be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Various implementations of the present disclosure have been described above, and the above description is exemplary, non-exhaustive, and not limited to the disclosed implementations. Many modifications and changes will be apparent to those of ordinary skill in the art without departing from the scope and spirit of the described implementations. The selection of terms used herein is intended to best explain the principles, practical applications, or improvements of the technology in the marketplace, or to enable other ordinary skill in the art to understand the various implementations disclosed herein.

I/we claim:

1. A method for training a multi-task model comprising a shared sub-model and a plurality of dedicated sub-models corresponding to a plurality of tasks respectively, comprising:
performing the following operations for each of the plurality of tasks respectively:
determining a trigger state of the task based on association information of the task;
in response to the trigger state indicating that the task is triggered for training the multi-task model, obtaining a set of training data corresponding to the task; and
training the shared sub-model and a dedicated sub-model corresponding to the task with the set of training data corresponding to the task.

2. The method of claim 1, further comprising:
after performing the operations for each of the plurality of tasks, increasing a count that represents a number of training steps by 1 to proceed to a next training step; and
in the next training step, performing the operations for each of the plurality of tasks respectively.

3. The method of claim 1, wherein performing the operations further comprises:
in response to the trigger state indicating that the task is not triggered for training the multi-task model, performing the operations for a next task of the plurality of tasks.

4. The method of claim 1, wherein performing the operations further comprises:
before training the shared sub-model and the dedicated sub-model corresponding to the task, maintaining model parameters of the shared sub-model unchanged and updating parameters of the dedicated sub-model associated with the task.

5. The method of claim 4, wherein a number of times of updating the parameters of the dedicated sub-model is preset.

6. The method of claim 1, wherein the association information of each task comprises at least one of:
a data loader corresponding to the task, wherein the data loader is associated with multiple sets of sample data for the task;
association model information corresponding to the task, wherein the association model information comprises dedicated sub-model information corresponding to the task;
loss information corresponding to the task; or
scheduling information corresponding to the task.

7. The method of claim 6, wherein determining the trigger state of the task comprises:
determining the trigger state of the task based on the scheduling information in the association information of the task, wherein the scheduling information comprises a trigger value of the task in at least one training step.

8. The method of claim 6, wherein obtaining the set of training data corresponding to the task comprises:
in response to the trigger state indicating that the task is triggered for training the multi-task model, determining a number of samples for training; and
obtaining, via the data loader, the set of training data with the number of samples from at least one set of training data of the multiple sets of sample data.

9. The method of claim 6, wherein performing the operations further comprises:
determining the dedicated sub-model corresponding to the task based on the association model information in the association information.

10. The method of claim 6, wherein first multiple sets of sample data associated with a first task of the plurality of tasks and second multiple sets of sample data associated with a second task of the plurality of tasks at least partially overlap.

11. The method of claim 6, wherein first multiple sets of sample data associated with a first task of the plurality of tasks and second multiple sets of sample data associated with a second task of the plurality of tasks do not overlap.

12. The method of claim 6, wherein the association information is represented by a quadruple.

13. An electronic device, comprising:
at least one processing unit;
at least one memory coupled to the at least one processing unit and storing instructions executable by the at least one processing unit, the instructions, when executed by the at least one processing unit, causing the electronic device to:
perform the following operations for each of the plurality of tasks respectively:
determine a trigger state of the task based on association information of the task;
in response to the trigger state indicating that the task is triggered for training the multi-task model, obtain a set of training data corresponding to the task; and
train the shared sub-model and a dedicated sub-model corresponding to the task with the set of training data corresponding to the task.

14. The device of claim 13, the device is further caused to:
after performing the operations for each of the plurality of tasks, increase a count that represents a number of training steps by 1 to proceed to a next training step; and
in the next training step, perform the operations for each of the plurality of tasks respectively.

15. The device of claim 13, wherein the device is further caused to:
in response to the trigger state indicating that the task is not triggered for training the multi-task model, perform the operations for a next task of the plurality of tasks.

16. The device of claim 13, wherein the device is further caused to:
before training the shared sub-model and the dedicated sub-model corresponding to the task, maintain model parameters of the shared sub-model unchanged and update parameters of the dedicated sub-model associated with the task.

17. The device of claim 16, wherein a number of times of updating the parameters of the dedicated sub-model is preset.

18. The device of claim 13, wherein the association information of each task comprises at least one of:
a data loader corresponding to the task, wherein the data loader is associated with multiple sets of sample data for the task;
association model information corresponding to the task, wherein the association model information comprises dedicated sub-model information corresponding to the task;
loss information corresponding to the task; or
scheduling information corresponding to the task.

19. The device of claim 18, wherein the instructions causing the device to determine the trigger state of the task comprises instructions causing the device to:
determine the trigger state of the task based on the scheduling information in the association information of the task, wherein the scheduling information comprises a trigger value of the task in at least one training step.

20. A non-transitory computer-readable storage medium having a computer program stored thereon, wherein the computer program, when executed by a processor, causing the processor to:
perform the following operations for each of the plurality of tasks respectively:
determine a trigger state of the task based on association information of the task;
in response to the trigger state indicating that the task is triggered for training the multi-task model, obtain a set of training data corresponding to the task; and
train the shared sub-model and a dedicated sub-model corresponding to the task with the set of training data corresponding to the task.
